(19) United States
(12) Patent Application Publication
(10) Pub. No.: US 2013/0214440 A1
(43) Pub. Date: Aug. 22, 2013

(54) LENS SHEET MANUFACTURING METHOD AND LENS SHEET MANUFACTURING APPARATUS

(71) Applicant: FUJIFILM Corporation, (US)

(72) Inventors: Ryuichi KATSUMOTO, Saitama-shi (JP); Yuji ONODA, Saitama-shi (JP); Kazuo ONISHI, Saitama-shi (JP)

(73) Assignee: FUJIFILM Corporation, Tokyo (JP)

(21) Appl. No.: 13/849,233

(22) Filed: Mar. 22, 2013

Related U.S. Application Data
(63) Continuation of application No. PCT/JP2011/065313, filed on Jul. 5, 2011.

(30) Foreign Application Priority Data
Sep. 24, 2010 (JP) 2010-214102

(51) Int. Cl. B29D 11/00

(52) U.S. Cl. CPC B29D 11/00951
USPC 264/1.36; 425/150

(57) ABSTRACT

A lens sheet manufacturing method according to one aspect of the presently disclosed subject matter includes: conveying an original lens sheet having a plurality of linear lens elements arranged and formed in parallel with each other on a front sheet surface; detecting an edge line of one of the lens elements; determining whether the detected edge line and a trimming direction blade included in a punching blade are parallel with each other; when it is determined that they are not parallel with each other, controlling a conveying direction of the original lens sheet so that the trimming direction blade and the detected edge line are parallel with each other; and temporarily stopping conveying with the edge line of the lens element and the trimming direction blade being parallel with each other and punching the original lens sheet with the punching blade to manufacture a separated lens sheet.

### CROSS-REFERENCE TO RELATED APPLICATIONS

This application is a PCT Bypass continuation application and claims the priority benefit under 35 U.S.C. §120 of PCT Application No. PCT/JP2011/065313 filed on Jul. 5, 2011 which application designates the U.S., and also claims the priority benefit under 35 U.S.C. §119 of Japanese Patent Application No. 2010-214102 filed on Sep. 24, 2010, which applications are all hereby incorporated in their entireties by reference.

### BACKGROUND OF THE INVENTION

1. Field of the Invention

The presently disclosed subject matter relates to a lens sheet manufacturing method and lens sheet manufacturing apparatus and, in particular, to a technology of punching, with a frame-shaped punching blade, a band-shaped original lens sheet having a large number of linear lens elements arranged in parallel with each other on a sheet surface to manufacture a separated lens sheet.

2. Description of the Related Art

A lenticular lens for 3D (three dimensional), a prism sheet for an LCD (liquid crystal display device), and others are configured with a large number of linear lens elements (for example, U-shaped or semi-cylindrical-shaped lenses) arranged in parallel with each other. In the case of the lens sheet (lenticular lens) for 3D described in Japanese Patent No. 3352879, as depicted in FIG. 7, an image layer 2 is recorded (for example, printed) on a rear surface of a lens sheet 1 and, by viewing the image layer 2 through the lens sheet 1, an image can be viewed as a stereoscopic image. In this case, for viewing of a stereoscopic image in a good condition, the print position is required to be printed so as to accurately correspond to the arrangement of the lens elements 3. That is, as depicted in FIG. 8A, a print head 4 performs printing so as to be positioned at a pitch P of the lens elements 3 while measuring a distance from an edge side 1A with reference to the position of the edge side 1A in a width direction of the lens sheet 1.

On the other hand, as for the lens sheet 1, an original lens sheet is punched with a frame-shaped punching blade, thereby manufacturing the separated quadrangular lens sheet 1. Conventionally, when the original lens sheet is punched with the frame-shaped punching blade to manufacture a separated lens sheet, the edge side of the original lens sheet is detected by using an edge position control method described in Japanese Patent Application Laid-Open No. 9-239728 and Japanese Patent Application Laid-Open No. 11-267754, and punching is performed with this edge side as a reference line so that the reference line and a trimming direction blade of the punching blade are parallel with each other.

### SUMMARY OF THE INVENTION

However, since the original lens sheet is manufactured by transferring lens elements to a molten resin sheet by a mold plate or a form roll, the edge side of the resin sheet and the lens elements may not be parallel with each other correctly. Also, it is general to trim an edge part (an edge part in a width direction) of the resin sheet after transfer, and the edge side of the resin sheet and the lens element may not be parallel with each other by trimming.

Therefore, when the original lens sheet is punched with reference to the edge side of the original lens sheet as in a conventional method, if the edge side of the original lens sheet and the lens elements are not parallel with each other, the edge side of the manufactured lens sheet 1 and the lens elements are not parallel with each other. In this case, as depicted in FIG. 8B, printing cannot be performed with the print position of the print head 4 accurately corresponding to the arrangement of the lens elements 3, thereby posing a problem in which a stereoscopic image in a good condition cannot be obtained. Generally speaking, correction with the print head 4 is difficult when the parallelism is degraded by one pitch P (by 254 μm) or more of the lens elements.

Also, as another method of positioning the print head 4 and the lens sheet 1, there is a method of detecting a lens edge line of the lens sheet 1 to detect a tilt of the lens edge line and tilting the lens sheet 1 in a printer for positioning with the print head, but in this case, a tilt exceeding one pitch P (254 μm) cannot be corrected in the printer. Therefore, also in the case of this positioning method, it is required that the edge side of the lens sheet and the lens elements be accurately parallel with each other.

The presently disclosed subject matter was made in view of these circumstances, and has an object of providing a method and apparatus of manufacturing a lens sheet suitable as, for example, a lenticular lens for 3D or a prism sheet for an LCD, since the edge side of the separated lens sheet after punching and the lens elements can be made accurately parallel with each other even when the edge side of the original lens sheet and the lens elements are not parallel with each other.

To achieve the object above, a lens sheet manufacturing method according to one aspect of the presently disclosed subject matter includes: a conveying step of conveying a band-shaped original lens sheet having a large number of linear lens elements arranged and formed in parallel with each other on a sheet front surface, an edge line detecting step of detecting an edge line of one of the lens element formed on the original lens sheet, a determining step of determining whether the detected edge line and a trimming direction blade included in a punching blade formed of the trimming direction blade and a cutting direction blade are parallel with each other, a conveying direction correcting step of, when it is determined in the determining step that the detected edge line and the trimming direction blade are not parallel with each other, controlling a conveying direction of the original lens sheet so that the detected edge line is parallel with respect to the trimming direction blade of the punching blade, and a punching step of temporarily stopping conveyance of the original lens sheet with the edge line of the lens element and the trimming direction blade of the punching blade being parallel with each other and punching the original lens sheet with the punching blade to manufacture a separated lens sheet.

Here, the trimming direction blade of the punching blade is a blade cutting along a longitudinal direction of the original lens sheet, and the cutting direction blade is a blade orthogonal to the trimming direction blade. Also, examples of a band-shaped lens sheet having a large number of linear lens elements arranged and formed in parallel with each other on a sheet front surface include a lenticular lens and a prism sheet. Also, the shape of the punching blade is normally a rectangular frame shape, but the presently disclosed subject matter is not restricted to a rectangular frame shape. The shape of the punching blade may be, for example, a circle, an oval, or others, and any shape will suffice.

According to the lens sheet manufacturing method according to the aspect described above, the edge line of the lens element is detected to determine whether the detected edge line and the trimming direction blade of the punching blade are parallel with each other, and if they are not parallel with each other, the conveying direction of the original lens sheet is controlled so that the detected edge line is parallel with respect to the trimming direction blade of the punching blade. Then, with the edge line being kept parallel with respect to the trimming direction blade, the lens sheet is punched. With this, even if the edge side of the original lens sheet and the lens elements are not parallel with each other, the edge side of a separated lens sheet obtained by punching and the lens elements reliably become parallel with each other. Therefore, at the time of printing, in both of the case in which the print head is positioned with reference to the edge side of the lens sheet and the case in which the tilt of the lens edge line is detected and the print head is positioned with the lens sheet being tilted in a printer, printing can be made with the print position accurately matching the arrangement of the lens elements. With this, a stereoscopic image can be viewed in a good condition.

In the edge line detecting step of the lens sheet manufacturing method according to the aspect described above, it is preferable to irradiate a rear surface of the original lens sheet with a light beam, image the front surface of the original lens sheet, and detect the edge line from contrast information of an image obtained from an imaging.

When the original lens sheet is irradiated with a light beam from the rear surface thereof, a valley part, which is a boundary between lens elements, looks dark, and an edge line part, which is a peak part of each lens element, looks bright. With this, the edge line of the lens element can be reliably detected with a simple method.

In the lens sheet manufacturing method according to the aspect described above, among the large number of lens elements, a detection-purpose lens element for detection of the edge line preferably has an identity different from those of other lens elements. With this, among the large number of lens elements arranged in parallel with each other, a lens element having an identity can be easily found. Therefore, even if the direction of conveying the original lens sheet is changed or the lot of the original lens sheet is changed, the lens element for edge line detection can be reliably tracked to detect the edge line.

In the lens sheet manufacturing method according to the aspect described above, it is preferable that the identity is provided by forming the detection-purpose lens element so that the detection-purpose lens element has a pitch width larger than pitch widths of the other lens elements, and that the lens element having the larger pitch width is formed outside a punching region to be punched in the punching step in the original lens sheet. In view of easy identification, the pitch width of the detection purpose lens elements is preferably larger than that of the other lens elements. In other words, an identity can be provided by forming the detection-purpose lens element larger than the other lens elements.

With this, the detection-purpose lens element for edge line detection can be easily and reliably found, and since the lens element for edge line detection is formed outside the punching region of the original lens sheet, optical characteristics of the separated lens sheet to be manufactured can be prevented from being adversely affected.

In the lens sheet manufacturing method according to the aspect described above, it is preferable that the original lens sheet be manufactured by compressing, with a form roller and a nip roller, a resin sheet in a melting state extruded from a die and transferring inverted shapes of the lens elements formed on a front surface of the form roller to the resin sheet for manufacture, and the inverted shape of the detection-purpose lens element be formed on the form roller.

Note that as a method of manufacturing an original lens sheet, other than the extrusion method, an extrusion laminate method (a method of laminating a base material on a sheet), a 2P method (a method of using an ultraviolet curable resin), and others can be adopted.

With this, a lens element having an identity can be formed at the same time when the original lens sheet is manufactured. Therefore, a special process or apparatus for providing an identity is not required. With this, production efficiency can be improved, and apparatus cost can be reduced.

Preferably, the lens sheets according to the aspect described above are lenticular lenses used for 3D and each having an image for 3D directly printed on a rear surface of the lens sheet.

This is because the presently disclosed subject matter is particularly effective in the case of a lenticular lens for 3D and for the purpose of direct printing of a 3D image.

To achieve the object described above, a lens sheet manufacturing apparatus according to one aspect of the presently disclosed subject matter includes: a conveying unit configured to convey a band-shaped original lens sheet having a large number of linear lens elements arranged in parallel with each other on a sheet front surface, an edge line detecting unit configured to detect an edge line of one of the lens elements formed on the original lens sheet, a frame-shaped punching blade formed of a trimming direction blade and a cutting direction blade, a determining unit configured to determine whether the detected edge line and the trimming direction blade of the punching blade are parallel with each other, a conveying direction correcting unit configured to control a conveying direction of the original lens sheet so that the detected edge line is parallel with respect to the trimming direction blade of the punching blade when it is determined by the determining unit that the detected edge line and the trimming direction blade are not parallel with each other, and a punching unit configured to temporarily stop conveyance of the original lens sheet with the edge line of the lens element and the trimming direction blade of the punching blade being parallel with each other and punch the original lens sheet with the punching blade to manufacture a separated lens sheet.

By using the lens sheet manufacturing apparatus according to the aspect described above, even if the edge side of the original lens sheet and the lens elements are not parallel with each other, the edge side of the separated lens sheet obtained by punching and the lens elements can be accurately made parallel with each other.

In the lens sheet manufacturing apparatus according to the aspect described above, the edge line detecting unit preferably includes a light-emitting unit configured to irradiate a rear surface of the original lens sheet with a light beam and an imaging unit provided on a front surface side of the original lens sheet and configured to image the front surface of the lens sheet.

As described above, when the original lens sheet is irradiated with a light beam from the rear surface thereof, a valley part, which is a boundary between lens elements looks dark, and an edge line part, which is a peak part of each lens element, looks bright. With this, the edge line of the lens element can be reliably detected with a simple apparatus.

In the lens sheet manufacturing apparatus according to the aspect described above, it is preferable that a unit configured to manufacture the original lens sheet include: a die configured to extrude a resin in a melting state into a sheet shape, a form roller configured to compress a resin sheet obtained by extrusion with a nip roller and transfer an inverted shape of the large number of lens elements formed on a roller front surface onto a front surface of the resin sheet, and a peel-off roller configured to peel the resin sheet obtained by transferring from the form roller, wherein among the large number of lens elements formed with the form roller, a detection-purpose lens element for detection of the edge line have a pitch width larger than those of other lens elements, and the detection-purpose lens element be formed at a corresponding position outside a punching region of the original lens sheet to be punched by the punching unit.

Note that, as described above, as a method of manufacturing an original lens sheet, other than the extrusion method, an extrusion laminate method (a method of laminating a base material on a sheet), a 2P method (a method of using an ultraviolet curable resin), and others can be adopted.

With this, a lens element having an identity can be formed at the same time when the original lens sheet is manufactured, and therefore a special process or apparatus for providing an identity is not required. With this, production efficiency can be improved, and apparatus cost can be reduced. Also, since the detection-purpose lens element for edge line detection is formed outside the punching region of the original lens sheet, optical characteristics of the separated lens sheet to be manufactured can be prevented from being adversely affected.

According to the lens sheet manufacturing method and lens sheet manufacturing apparatus in accordance with the presently disclosed subject matter, even if the edge side of the original lens sheet and the lens elements are not parallel with each other, punching can be made so that the edge side of the separated lens sheet obtained by punching and the lens elements are accurately parallel with each other. Therefore, for example, a lens sheet suitable as a lenticular lens for 3D or a prism sheet for a LCD can be manufactured.

### BRIEF DESCRIPTION OF THE DRAWINGS

FIG. 1 is a schematic diagram of an original sheet manufacturing apparatus for manufacturing a band-shaped original lens sheet.

FIG. 2 is a perspective view of a separated-sheet manufacturing apparatus for manufacturing a separated lens sheet.

FIG. 3 is a plan conceptual view of a separated-sheet manufacturing apparatus for manufacturing a separated lens sheet.

FIG. 4 is a drawing for describing an edge line detecting unit.

FIG. 5A is a drawing for describing that a band-shaped original lens sheet is punched to manufacture a separated lens sheet.

FIG. 5B is a drawing for describing that a band-shaped original lens sheet is punched to manufacture a separated lens sheet.

FIG. 6 is a drawing for describing a method of manufacturing a detection-purpose lens element.

FIG. 7 is a drawing for describing a 3D lenticular lens and an image layer.

FIG. 8A is a drawing for describing that an image layer is formed on the lenticular lens.

FIG. 8B is a drawing for describing that the image layer is formed on the lenticular lens.

### DETAILED DESCRIPTION OF THE EMBODIMENTS

Embodiments of a lens sheet manufacturing method and lens sheet manufacturing apparatus according to the presently disclosed subject matter are described in detail below.

Note that in the embodiments of the presently disclosed subject matter, an example of a lenticular lens having a large number of lens elements of U-shaped convex lenses arranged in parallel with each other is described as a lens sheet. Also, while an example is described in the present embodiment in which quadrangular-shaped lens sheets are formed by punching with a punching blade in a rectangular frame shape, the shape of each lens sheet to be manufactured is not restricted to a quadrangle. The shape of the lens sheet to be manufactured may be, for example a circle, an oval, or others, and is not restricted by any shape.

A lens sheet manufacturing apparatus of the presently disclosed subject matter punches a band-shaped original lens sheet having a large number of linear lens elements (U-shaped convex lenses) arranged and formed in parallel with each other on a sheet front surface with a rectangular-frame shaped punching blade formed of a trimming direction blade and a cutting direction blade to manufacture a separated lens sheet. Therefore, prior to description of a method of manufacturing a separated lens sheet by punching an original lens sheet, one preferable example of manufacturing an original lens sheet is described first.

### Manufacturing Band-Shaped Original Lens Sheet

Note that while an extrusion method is taken as an example of a method of manufacturing an original lens sheet in the present embodiment, the presently disclosed subject matter is not restricted to this. As a method of manufacturing an original lens sheet, an extrusion laminate method (a method of laminating a base material on a sheet), a 2P method (a method of using an ultraviolet curable resin), and others can be applied.

An original sheet manufacturing apparatus 11 includes a die 12 extruding a resin in a melting state in a sheet shape, a form roller 16 compressing, with a nip roller 14, a extruded resin sheet 10 and transferring a predetermined pattern shape formed on a front surface of the form roller 16 to a front surface of the resin sheet 10, and a peeling roller 18 peeling the transferred resin sheet 10 off the form roller 16.

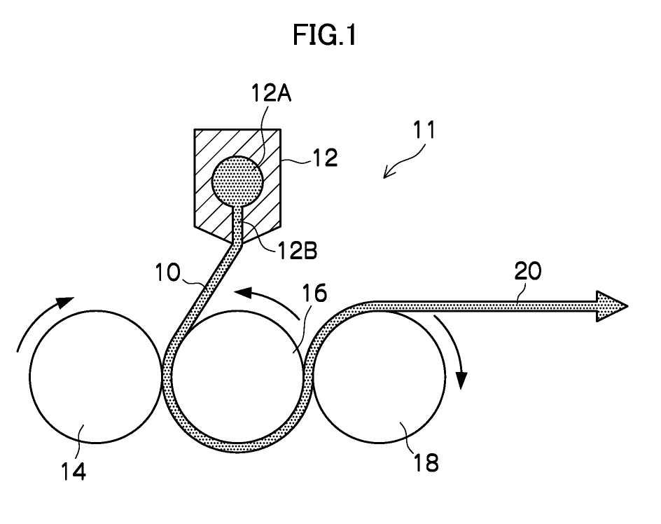

Inside the die 12, a manifold 12A to which molten resin molten in an extruder (not illustrated) is supplied to flow in an expanded manner (flow in an expanded manner in a front and rear direction of FIG. 1) and a slit 12B serving as a narrow flow path for extruding the molten resin inside the manifold 12A are formed. The molten resin inside the manifold 12A is extruded from the tip of the slit 12B in a sheet shape, thereby forming the resin sheet 10.

Also, on a roller front surface of the form roller 16, inverted shapes of lenticular lenses are formed as a pattern shape. That is, on the roller front surface, a large number of inverted shapes of lens elements, which are fine, elongated, U-shaped (semicircular) convex lenses, are arranged and formed in a roller circumferential direction.

As a material of the form roller 16, any of metal materials such as various steel members, stainless steel, copper, zinc, and brass; those having any of these metal materials as a cored bar whose front surface is subjected to rubber lining; those having any of these metal materials subjected to plating such as HCr plating, Cu plating, or Ni plating; ceramic; and various composites can be adopted.

A pattern forming method for forming a pattern on the front surface of the form roller 16 is selected according to the pattern (such as a pitch or a depth) and the material of the front surface of the form roller 16. As the pattern forming method, in general, a combination of a grinding process and a finishing buff process with an NC (Numerical Control) lathe can be preferably adopted. Also, as the pattern forming method, another known processing method (grinding process, ultrasound process, electric discharge process, or the like) can also be adopted.

The surface roughness of the front surface of the form roller 16 is preferably 0.5 μm or smaller in Ra, more preferably 0.2 μm or smaller.

The form roller 16 is driven by rotation by a driving unit not illustrated in an arrow direction of FIG. 1 at a predetermined peripheral velocity V1. Also, the form roller 16 is preferably provided with a temperature adjusting unit not illustrated, inhibiting an increase in temperature of the form roller 16 due to the melting resin sheet 10 in a high temperature state and an abrupt decrease in temperature of the form roller 16.

The nip roller 14 is a roller placed so as to face the form roller 16 to compress the resin sheet 10 with the form roller 16. The nip roller 14 has a height equal to the height of the form roller 16, and is placed in parallel with the form roller 16.

The roller front surface of the nip roller 14 is preferably processed as being mirror-finished. With this roller surface, the rear surface of the resin sheet 10 after forming can be in a good condition. Specifically, the surface roughness of the front surface of the nip roller 14 is preferably 0.5 μm or smaller in Ra, more preferably 0.2 μm or smaller.

As a material of the nip roller 14, any of metal materials such as various steel members, stainless steel, copper, zinc, and brass; those having any of these metal materials as a cored bar whose front surface is subjected to rubber lining; those having any of these metal materials subjected to plating such as HCr plating, Cu plating, or Ni plating; ceramic; and various composites can be adopted.

The nip roller 14 is driven by rotation by a driving unit not illustrated in an arrow direction of FIG. 1 at the predetermined peripheral velocity V1. Note that while the nip roller 14 can be configured not to be provided with a driving unit, a driving unit is preferably provided because the rear surface of the resin sheet 10 can be in a good state.

The nip roller 14 is provided with a pressuring unit not illustrated, allowing the resin sheet 10 between the nip roller 14 and the form roller 16 to be compressed at a predetermined pressure. This pressuring unit is configured to apply pressure in the direction of the normal at a contact point between the nip roller 14 and the form roller 16. As this pressuring unit, any of various known apparatus such as a motor driving unit, an air cylinder, and a hydraulic cylinder can be adopted.

The nip roller 14 can also adopt a structure in which a bending due to counterforce of the compression force tends not to occur. As this structure, any of the structures as follows and a combination thereof can be adopted: the structure in which a backup roller (not illustrated) is provided to the rear surface side (an opposite side of the form roller 16) of the nip roller; the structure in which a crown shape (this is assumed to be a middle height shape) is adopted; and a strength distribution with high stiffness at a center portion in an axial direction of the nip roller 14 is provided.

The nip roller 14 is also preferably provided with a temperature adjusting unit not illustrated. The set temperature of the nip roller 14 is preferably set at an optimum value depending on the material of the resin sheet 10, the temperature of the resin sheet 10 at the time of melting (for example, an exit of the slit 12B of the die 12), the conveying speed of the molten resin sheet 10, the outer diameter of the form roller 16, the pattern shape of the form roller 16, and others.

The peeling roller 18 is a roller placed to face the form roller 16 to cause the resin sheet 10 to be wound around the peeling roller 18 to peel the resin sheet 10 off the form roller 16. The peeling roller 18 is placed on a downstream side of the nip roller 14 by 180 degrees across the form roller 16. That is, the peeling roller 18 is placed at the same height as the height of the form roller 16 in parallel with the form roller 16.

A roller front surface of the peeling roller 18 is preferably processed as being mirror-finished. With this front surface, the rear surface of the molten resin sheet 10 after transfer can be in a good condition. Specifically, the surface roughness of the front surface of the peeling roller 18 is preferably 0.5 μm or smaller in Ra, more preferably 0.2 μm or smaller.

As a material of the peeling roller 18, any of metal materials such as various steel members, stainless steel, copper, zinc, and brass; those having any of these metal materials as a cored bar whose front surface is subjected to rubber lining; those having any of these metal materials subjected to plating such as HCr plating, Cu plating, or Ni plating; ceramic; and various composites can be adopted.

The peeling roller 18 is driven by rotation by a driving unit not illustrated in an arrow direction of FIG. 1 at the predetermined peripheral velocity V1. Note that while the peeling roller 18 can be configured not to be provided with a driving unit, a driving unit is preferably provided in order to keep the rear surface of the resin sheet 10 in a good state.

Also, the peeling roller 18 is preferably provided with a temperature adjusting unit not illustrated. With the peeling roller 18 being set at an appropriately set temperature, the pattern shape on the front surface of the resin sheet 10 can be in a good state.

Next, the method of manufacturing an original lens sheet by the manufacturing apparatus illustrated in FIG. 1 is described.

Examples of the resin material for use in manufacturing the original lens sheet 20 include a polymethyl methacrylate resin (PMMA), a polycarbonate resin, a polystyrene resin, an MS resin (methylmethacrylate styrene), an AS resin (a copolymer of acrylonitrile and styrene), a polypropylene resin, a polyethylene resin, a polyethylene terephthalate resin, a polyvinyl chloride resin (PVC), a thermoplastic elastomer, and a copolymer thereof, and a cycloolefin polymer.

The sheet-shaped resin sheet 10 extruded from the die 12 is compressed between the rotating form roller 16 and the nip roller 14 placed to face the form roller 16, and the pattern shape on the front surface of the form roller 16 is transferred to the molten resin sheet 10. Then, as being wound around the peeling roller 18 placed to face the form roller, the transferred molten resin sheet 10 is peeled off the form roller 16.

With this, the band-shaped original lens sheet 20 having the large number of lens elements 3 arranged and formed in parallel with each other on the sheet front surface is manufactured. The lens elements 3 are formed along a longitudinal direction of the band-shaped original lens sheet 20.

Next, description is made to a separated-sheet manufacturing apparatus 22 for manufacturing a separated lens sheet by punching the original lens sheet 20 with a punching blade formed of a trimming direction blade and a cutting direction blade. By once rolling the original lens sheet 20 manufactured by the original sheet manufacturing apparatus 11, the original sheet manufacturing apparatus 11 and the separated-sheet manufacturing apparatus 22 may be on different lines or may be on a series of contiguous lines in continuation.

### Manufacturing Separated Lens Sheet

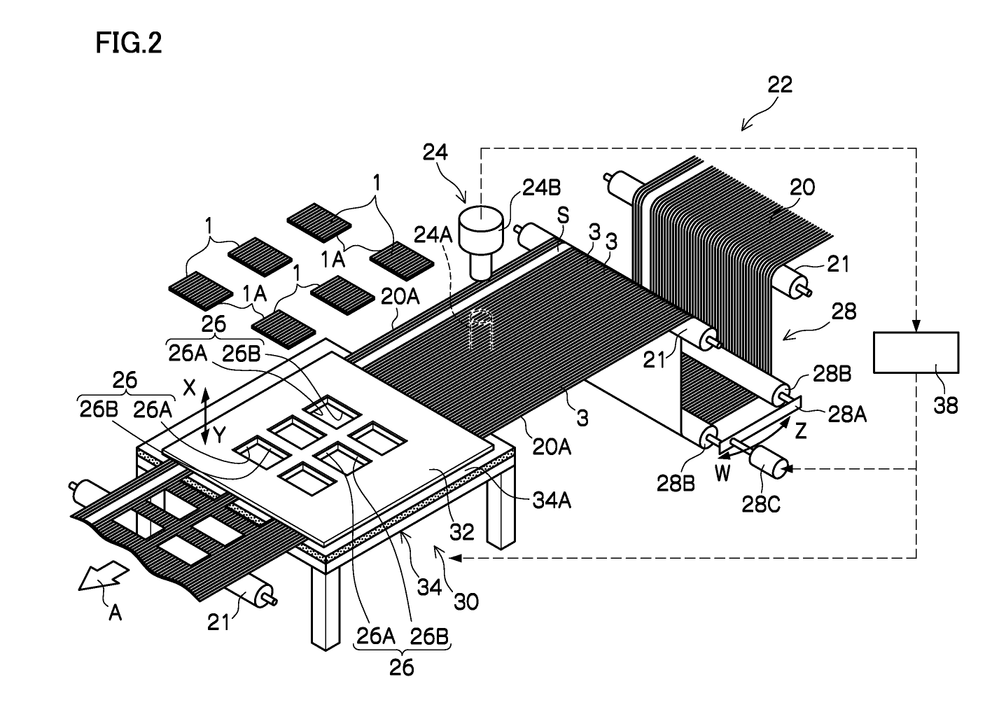

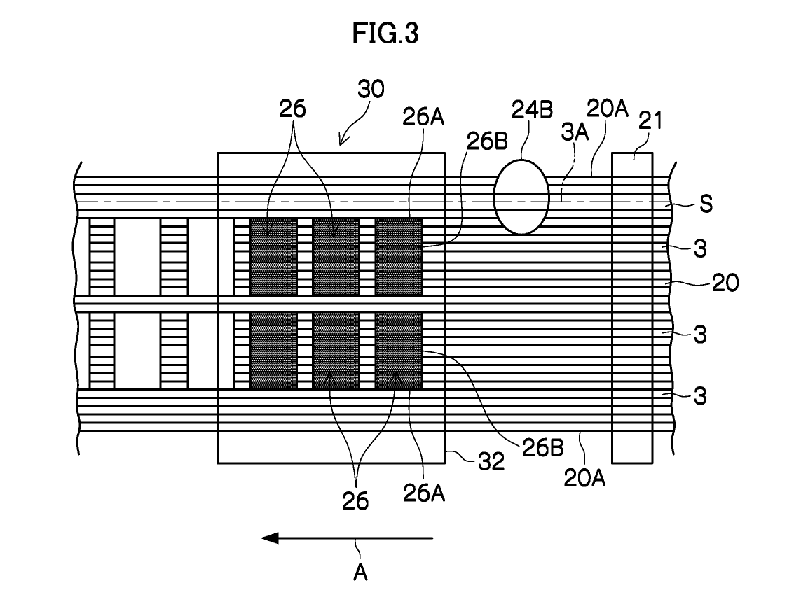

FIG. 2 is a perspective view of a separated-sheet manufacturing apparatus 22 for manufacturing a separated lens sheet s according to one embodiment of the presently disclosed subject matter, and FIG. 3 is a plan conceptual view of the separated-sheet manufacturing apparatus 22 when viewed from above. Note that each punching blade 26 is in a frame shape, and the punching blade 26 is depicted as a black rectangle for easy understanding a portion to be punched in the plan conceptual view of FIG. 3.

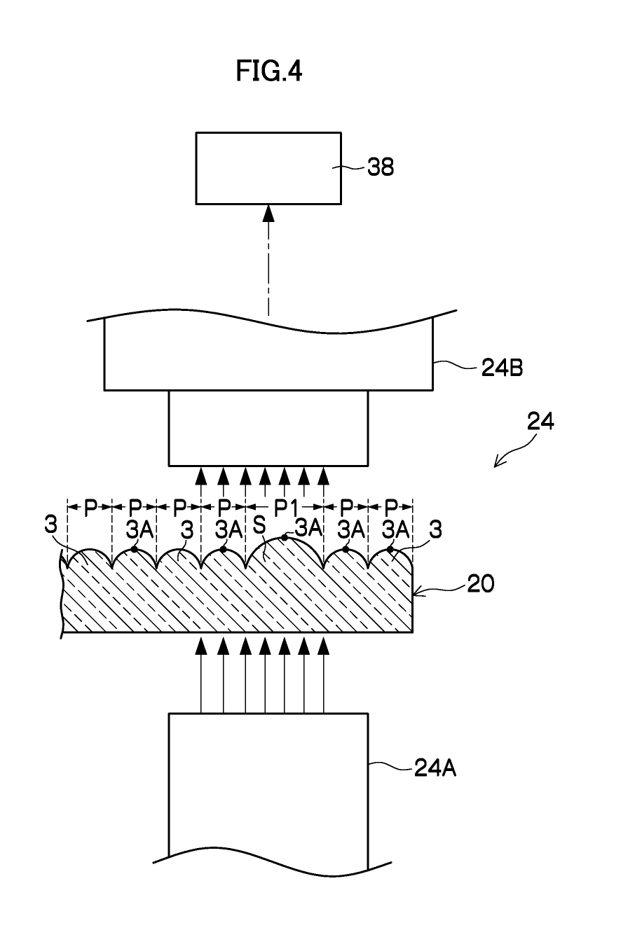

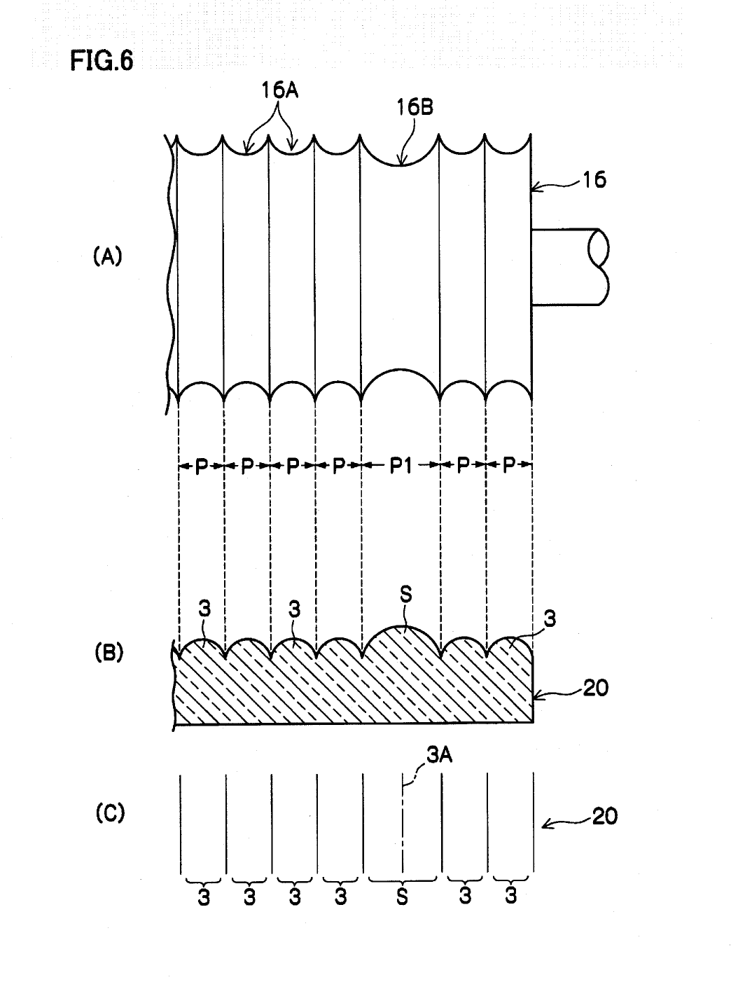

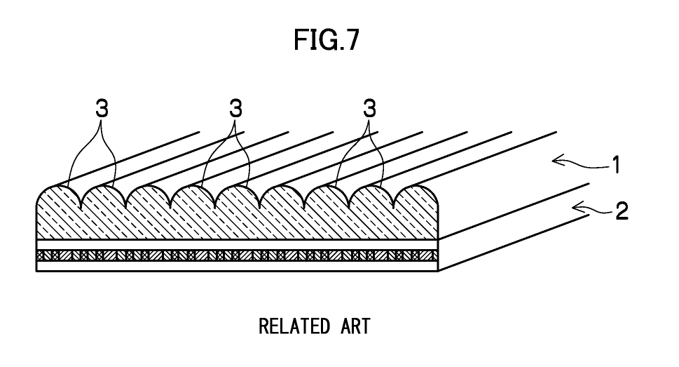

As depicted in FIG. 2 and FIG. 3, the separated-sheet manufacturing apparatus 22 includes: a conveying unit (not illustrated) conveying the original lens sheet 20 and temporarily stopping conveyance at the time of punching, an edge line detecting unit 24 detecting an edge line 3A (refer to FIG. 3, FIG. 4, and FIG. 6) of the lens element 3 in the original lens sheet 20, a determining unit determining whether the detected edge line 3A and the trimming direction blade 26A of the punching blade 26 are parallel with each other, a conveying direction correcting unit 28, when No is determined in the above determination (when it is determined that the edge line 3A and the trimming direction blade 26A are not parallel with each other), correcting the conveying direction of the original lens sheet 20 so that the detected edge line 3A is parallel with respect to the trimming direction blade 26A, and a punching unit 30 punching the original lens sheet 20 with the punching blade 26. These conveying unit, edge line detecting unit 24, conveying direction correcting unit 28, and the punching unit 30 are controlled by the controller 38, and the determining unit is incorporated in the controller 38.

The conveying unit includes a winding device (not illustrated) winding the band-shaped original lens sheet 20 and many path rollers 21 arranged on a conveyance route of the original lens sheet 20. With the original lens sheet 20 wound by the winding device, the original lens sheet 20 is conveyed in an arrow A direction. In addition to the winding device, the conveyance route may be provided with a nip driving roller for nipping the original lens sheet 20, a suction drum suctioning the rear surface of the original lens sheet 20 onto a rotating drum front surface, and others.

The punching unit 30 is provided above the original lens sheet 20 to be conveyed (on a front surface side of the original sheet 20), and includes a cutter holding plate 32 moving up and down by a lifting device not illustrated in an arrow X-Y direction and a cutter cradle 34 provided downward (on a rear surface side of the original sheet 20). While the lifting device is not particularly restrictive as long as it can accurately move the cutter holding plate 32 up and down, for example, a cylinder mechanism, a crank mechanism, or others can be adopted.

The cutter holding plate 32 has three rectangular-shaped (frame-shaped) punching blades 26 in the direction of conveying the original lens sheet 20 and two in a width direction of the original lens sheet 20, that is, six in total, in an accurately aligned state. The punching blades 26 are each formed in a so-called Thomson blade structure exhibiting a rectangular frame shape by paired trimming direction blades 26A, 26A in parallel with each other along the direction of conveying the original lens sheet 20 and paired cutting direction blades 26B, 26B in parallel with each other orthogonal to the trimming direction blades 26A, 26A. The punching blade 26 heads downward, and is formed so as to protrude downward from a lower surface of the cutter holding plate 32 by a predetermined length.

On the other hand, the cutter cradle 34 is placed and fixed, and has a flat receiving surface with which the punching blades 26 collide, where an underlay film 34A for preventing the punching blades 26 from being damaged is placed. As the underlay film 34A, for example, polyethylene terephthalate (PET) can be suitably used. PET has suitable hardness as an underlay film, has excellent durability, and has properties such that a foreign substance is less prone to occur even if the punching blades 26 dig into the film.

According to the punching unit 30 configured as described above, the conveyed band-shaped original lens sheet 20 is temporarily stopped, the cutter holding plate 32 is moved downward, and the punching blades 26 collide with the cutter cradle 34 via the original lens sheet 20. With this, six separated lens sheets 1 can be punched in one operation.

The cutter holding plate 32 and the cutter cradle 34 are positioned so as to punch a punching region at a center portion in a width direction of the conveyed original sheet 20.

As the edge line detecting unit 24, a translucent edge line detecting unit depicted in FIG. 4 can be used.

As depicted in FIG. 4, this edge line detecting unit 24 includes a light-emitting unit 24A irradiating the rear surface of the original lens sheet 20 with a light beam and an imaging unit 24B provided on a front surface side of the original lens sheet 20 and imaging the front surface of the original lens sheet 20 to detect the edge line 3A of the lens element 3. As the imaging unit 24B, a CCD (charge-coupled device) camera can be suitably used. In the following, description is made with an example in which a CCD camera 24B is taken as the imaging unit 24B.

Preferred conditions of the line edge detecting unit 24 are as follows.

As a light source of the light-emitting unit 24A, red of an LED (light-emitting diode) flat illumination of approximately 50 mm square can be suitably used. The color of the illumination is not restricted to red, but may be white, blue, or green.

A distance between the original lens sheet 20 and the light-emitting unit 24A is approximately 30 mm. The light-emitting unit 24A is placed so as to face a lens of the CCD camera 24B. Since the distance between the original lens sheet 20 and the light-emitting unit 24A is varied depending on the lens shape, illumination size, and others, an adjustment is preferably made so that a boundary between the lens elements 3 is a black line.

As the CCD camera 24B, eight hundred thousand pixel gray CCD camera can be suitably used. However, a color camera is desirable depending on measurement accuracy.

As a lens of the CCD camera 24B, a telecentric, 0.5-fold lens having a work distance of 65 mm can be suitably used. However, a non-telecentric lens or a CCTV lens can be used as a lens of the CCD camera 24B depending on measurement accuracy. Also, the magnifying power of the CCD camera 24B is set based on a relation between measurement accuracy (for example, 10 μ/pixel) and a visual field size (for example, 9 mm×6 mm). While measurement accuracy is increased as the magnifying power of the CCD camera 24B is increased, the visual field of the CCD camera 24B is narrowed, and therefore, it is required to convey the original lens sheet 20 with high accuracy.

The CCD camera 24B is positioned and fixed above the lens element 3 for detection of the edge line 3A among the large number of lens elements 3 formed on the original lens sheet 20.

According to the edge line detecting unit 24 configured as described above, when the rear surface of the original lens sheet 20 is irradiated with a light beam from the light emitting unit 24A and the front surface of the original lens sheet 20 is imaged by the CCD camera 24B, a valley part, which is a boundary between the lens elements 3, looks dark, and an edge line part 3A, which is a peak part of each lens element, looks bright. With this, the edge line 3A of the lens element 3 can be detected by the CCD camera 24B. In this case, the large number of U-shaped lens elements 3 arranged in parallel with each other on the sheet front surface of the original lens sheet 20 are extremely fine straight lines each having a pitch width P of normally 254 μm. Therefore, there is worry that, if the direction of conveying the original lens sheet 20 is changed or the lot of the original lens sheet 20 is changed, it may be impossible to identify the edge line of which lens element 3 that is to be detected.

Thus, in the embodiment of the presently disclosed subject matter, as depicted in FIG. 4, a detection-purpose lens element S for detection of the edge line 3A is formed so as to have a pitch width P1 larger than a pitch width P of the other lens element 3, thereby providing an identity. In the following, an example is described in which the edge line 3A of the detection-purpose lens element S is detected.

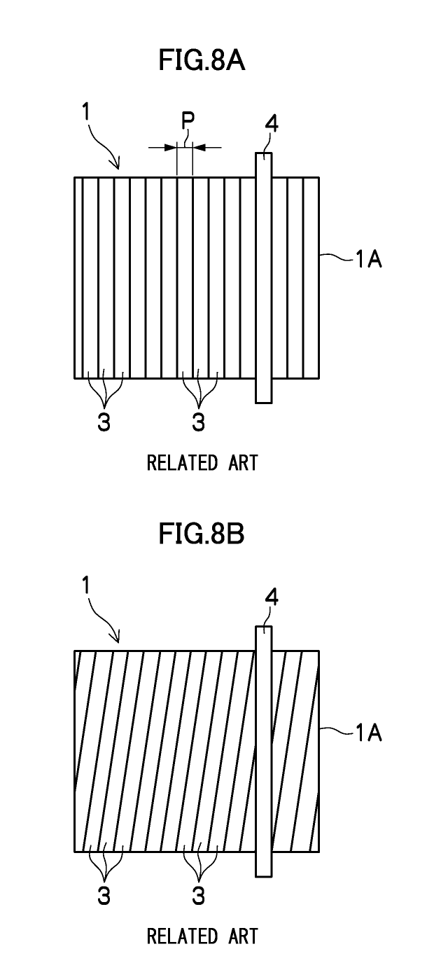

As depicted in FIG. 2 and FIG. 4, the image of the edge line 3A of the detection-purpose lens element S imaged by the CCD camera 24B is captured in the controller 38. The controller 38 has captured in advance, as a reference edge line (not illustrated), image data of the edge line 3A imaged by the CCD camera 24B under a condition in which the trimming direction blade 26A of the punching blade 26 and the edge line 3A of the detection-purpose lens element S are parallel with each other. Then, the controller 38 determines whether the edge line 3A imaged by the CCD camera 24B is parallel with respect to the reference edge line captured in advance. When the imaged edge line 3A is not parallel with the reference edge line, the conveying direction correcting unit 28 is controlled to correct the direction of conveying the original lens sheet 20 so that the imaged edge line 3A is parallel with the reference edge line. In the case of a lenticular lens for 3D, in the separated lens sheet 1 manufactured by punching, if the parallelism between the edge side 1A of the lens sheet 1 and the edge line 3A of the lens element 3 is degraded by one lens element pitch (by 254 μm) or more, a correction with the print head 4 (refer to FIG. 8) is difficult. Therefore, they can be regarded as being parallel with each other if the degradation is within one lens element pitch, and also for the parallelism between the edge line 3A of the detection-purpose lens element S imaged by the CCD camera 24B and the reference edge line captured in advance, it can be determined as to whether they are parallel with each other at a similar parallelism level. Note that the lens elements 3 are each formed so that, if the edge line 3A of the detection-purpose lens element S is parallel with the reference edge line, the edge lines 3A of the other lens elements 3 are also parallel with the reference edge line.

As depicted in FIG. 2, as the conveying direction correcting unit 28, for example, an EPC device (an edge position controller) can be used, and is controlled with a control signal from the controller 38. The EPC device includes paired activation rollers 28B, 28B coupled via a swing plate 28A and a cylinder 28C with a tip of a cylinder rod pin-connected to the swing plate 28A. With the cylinder rod performing a expanding and contracting operation, the paired activation rollers 28B and 28B swing about a pin in an arrow W-Z direction. With this, the direction of conveying the original lens sheet 20 can be corrected.

Next, a method of manufacturing the separated lens sheet 1 by the separated-sheet manufacturing apparatus 22 configured as described above is described.

The edge line 3A of the detection-purpose lens element S on the conveyed original lens sheet 20 is detected by the CCD camera 24B, and the detected edge line 3A is inputted to the controller 38.

The controller 38 compares the detected edge line 3A and a reference edge line captured in advance to determine whether these are parallel with each other.

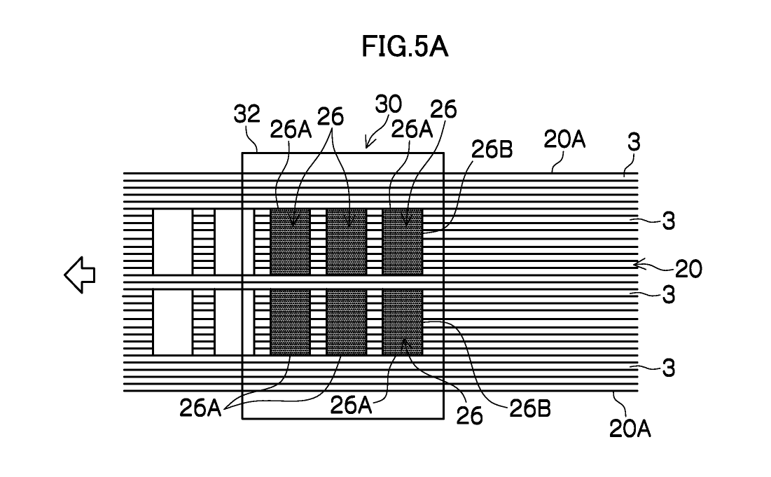

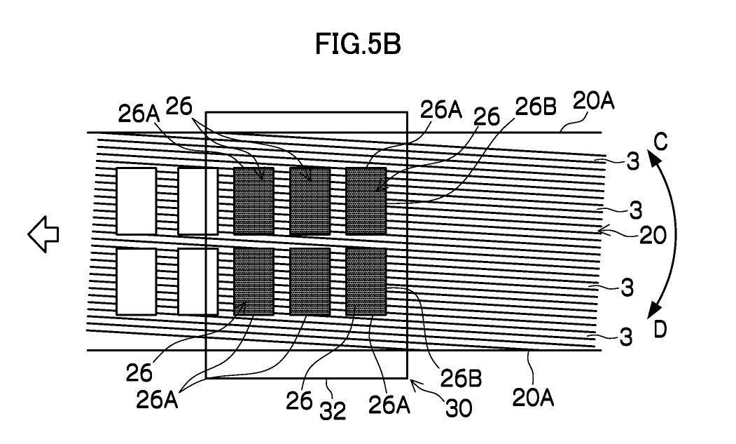

Then, when the detected edge line 3A and the reference edge line captured in advance are parallel with each other, the conveying unit is controlled to temporarily stop conveyance of the original lens sheet 20, and the punching unit 30 is controlled to punch the original lens sheet 20 with the punching blade 26. With this, as depicted in FIG. 5A, with the large number of lens elements 3 arranged in parallel with each other on the sheet surface of the original lens sheet 20 and the trimming direction blade 26A of each punching blade 26 being parallel with each other, the lens sheet 1 can be manufactured by punching.

Also, when the detected edge line 3A and the reference edge line captured in advance are not parallel with each other, as depicted in FIG. 5B, the trimming direction blade 26A of the punching blade 26 and the lens elements 3 are not parallel with each other, and therefore, the controller 38 controls the conveying direction correcting unit 28 so that the detected edge line 3A and the reference edge line are parallel with each other. In the case of FIG. 5B, the direction of conveying the original lens sheet 20 is swung to a C direction with respect to the punching unit 30. Then, once the edge line 3A and the reference edge line are parallel with each other, the controller 38 controls the conveying unit and the punching unit 30 to punch the original lens sheet 20 with the punching blade 26. Therefore, the edge line detecting unit 24 is preferably provided immediately before the punching unit 30.

With this, even when the edge side 20A of the original lens sheet 20 and the lens elements 3 are not parallel with each other, the edge side 1A of the separated lens sheet 1 obtained by punching (refer to FIG. 2) and the lens elements 3 reliably become parallel with each other. Therefore, for example, when the lens sheet 1 is a lenticular lens for 3D, the print head 4 prints with reference to the edge side 1A of the lens sheet 1, and printing can be made with the print position accurately corresponding to the arrangement of the lens elements 3. With this, a stereoscopic image in a good condition can be viewed.

Note that the detection-purpose lens element S for providing an identity is preferably formed at the same time when the original lens sheet 20 described with reference to FIG. 1 is manufactured.

That is, as depicted in (A) of FIG. 6, as inverted shapes of the lenticular lenses to be formed on the roller surface of the form roller 16, in addition to inverted shapes 16A of the lens elements 3 with the predetermined pitch width P, an inverted shape 16B corresponding to the identification-purpose lens element S with the pitch width P1 is formed. In this case, the inverted shape 16B of the identification-purpose lens element S is formed in a non-punching region in an edge portion in a width direction other than a punching region at a center portion in the width direction of the original lens sheet 20 described above.

By using thus formed form roller 16, the inverted shapes of the lenticular lenses are transferred to the front surface of the molten resin sheet extruded from the die 12, and therefore, as depicted in (B) of FIG. 6, the original lens sheet 20 having the detection-purpose lens element S can be manufactured.

Then, as depicted in (C) of FIG. 6, the controller 38 extracts the detection-purpose lens element S with the pitch width P1 from the image imaged by the CCD camera 24B, causing the edge line 3A of the extracted detection-purpose lens element S to be captured by the controller 38. With this, even if the direction of conveying the original lens sheet 20 is changed or the lot of the original lens sheet 20 is changed, the detection-purpose lens element S for detection of the edge line 3A can be easily and reliably found. Also, since the detection-purpose lens element S for edge line detection is formed outside the punching region of the original lens sheet 20, optical characteristics of the separated lens sheet 1 to be manufactured are not adversely affected.

Note that while an example is described in the present embodiment in which a translucent unit formed of the light-emitting unit 24A and the CCD camera 24B is used as the edge line detecting unit 24, a laser distance measuring equipment for detecting the edge line 3A by irradiating the lens elements 3 over a pitch width direction with a pencil of laser light can be used. Specifically, in this scheme, it is utilized that the distance from the laser distance measurement equipment to the valley part between the lens elements 3 is the longest, and the distance to the edge line 3A as a peak part is the shortest. Also in this case, as depicted in FIG. 4 and FIG. 6, it is preferable to form the detection-purpose lens element S having the pitch width P1 larger than those of the other lens elements 3, in other words, having a larger radius, so that the laser distance measuring equipment can easily find the detection-purpose lens element S even if the direction of conveying the original lens sheet 20 is changed or the lot is changed.

Also, while an example is described in the present embodiment in which the pitch width of the lens element is increased as a method for identifying the detection-purpose lens element S, conversely, the pitch width may be decreased. Furthermore, the shape of the detection-purpose lens element may be changed in a manner such that only the detection-purpose lens element takes not a U shape but a triangular shape. In short, any structure or shape can be applied as long as the edge line of the lens element can be detected and the lens element can be discriminable from other lens elements.

What is claimed is:

1. A lens sheet manufacturing method, comprising:
a conveying step of conveying a band-shaped original lens sheet having a large number of linear lens elements arranged and formed in parallel with each other on a sheet front surface;
an edge line detecting step of detecting an edge line of one of the lens elements formed on the original lens sheet;
a determining step of determining whether the detected edge line and a trimming direction blade included in a punching blade formed of the trimming direction blade and a cutting direction blade are parallel with each other;
a conveying direction correcting step of, when it is determined in the determining step that the detected edge line and the trimming direction blade are not parallel with each other, controlling a conveying direction of the original lens sheet so that the detected edge line is parallel with respect to the trimming direction blade of the punching blade; and
a punching step of temporarily stopping conveyance of the original lens sheet with the edge line of the lens element and the trimming direction blade of the punching blade being parallel with each other and punching the original lens sheet with the punching blade to manufacture a separated lens sheet.

2. The lens sheet manufacturing method according to claim 1, wherein
in the edge line detecting step, a rear surface of the original lens sheet is irradiated with a light beam, the front surface of the original lens sheet is imaged, and the edge line is detected from contrast information of an image obtained from an imaging.

3. The lens sheet manufacturing method according to claim 1, wherein
among the large number of lens elements, a detection-purpose lens element for detection of the edge line has an identity different from those of other lens elements.

4. The lens sheet manufacturing method according to claim 2, wherein
among the large number of lens elements, a detection-purpose lens element for detection of the edge line has an identity different from those of other lens elements.

5. The lens sheet manufacturing method according to claim 3, wherein
the identity is provided by forming the detection-purpose lens element so that the detection-purpose lens element has a pitch width larger than pitch widths of the other lens elements, and
the lens element having the larger pitch width is formed outside a punching region to be punched in the punching step in the original lens sheet.

6. The lens sheet manufacturing method according to claim 5, wherein
the original lens sheet is manufactured by compressing, with a form roller and a nip roller, a resin sheet in a melting state extruded from a die and transferring inverted shapes of the lens elements formed on a front surface of the form roller to the resin sheet for manufacture, and the inverted shape of the detection-purpose lens element is formed on the form roller.

7. The lens sheet manufacturing method according to claim 1, wherein
the lens sheets are lenticular lenses used for 3D and each having an image for 3D directly printed on a rear surface of the lens sheet.

8. A lens sheet manufacturing apparatus comprising:
a conveying unit configured to convey a band-shaped original lens sheet having a large number of linear lens elements arranged in parallel with each other on a sheet front surface;
an edge line detecting unit configured to detect an edge line of one of the lens elements formed on the original lens sheet;
a frame-shaped punching blade formed of a trimming direction blade and a cutting direction blade;
a determining unit configured to determine whether the detected edge line and the trimming direction blade of the punching blade are parallel with each other;
a conveying direction correcting unit, when it is determined by the determining unit that the detected edge line and the trimming direction blade are not parallel with each other, configured to control a conveying direction of the original lens sheet so that the detected edge line is parallel with respect to the trimming direction blade of the punching blade; and
a punching unit configured to temporarily stop conveyance of the original lens sheet with the edge line of the lens element and the trimming direction blade of the punching blade being parallel with each other and punch the original lens sheet with the punching blade to manufacture a separated lens sheet.

9. The lens sheet manufacturing apparatus according to claim 8, wherein
the edge line detecting unit includes:
a light-emitting unit configured to irradiate a rear surface of the original lens sheet with a light beam, and
an imaging unit provided on a front surface side of the original lens sheet and configured to image the front surface of the lens sheet.

10. The lens sheet manufacturing apparatus according to claim 8, wherein
a unit configured to manufacture the original lens sheet includes a die configured to extrude a resin in a melting state into a sheet shape, a form roller configured to compress a resin sheet obtained by extrusion with a nip roller and transfer an inverted shape of the large number of lens elements formed on a roller front surface onto the front surface of the resin sheet, and a peel-off roller configured to peel the resin sheet obtained by transferring from the form roller, wherein
among the large number of lens elements formed with the form roller, a detection-purpose lens element for detection of the edge line has a pitch width larger than those of other lens elements, and
the detection-purpose lens element is formed at a corresponding position outside a punching region of the original lens sheet to be punched by the punching unit.
